(19) United States
(12) Patent Application Publication
(10) Pub. No.: US 2026/0106443 A1
(43) Pub. Date: Apr. 16, 2026

(54) ELECTRICAL ASSEMBLY

(71) Applicant: Lear Corporation, Southfield, MI (US)

(72) Inventors: Marc Deumal, L’Argilaga (ES); Eric Salem, Berkley, MI (US); Carles Vilella Parra, Sant Cugat Sesgarrigues (ES); Samuel Muskett, Birmingham, MI (US)

(73) Assignee: Lear Corporation, Southfield, MI (US)

(21) Appl. No.: 18/913,078

(22) Filed: Oct. 11, 2024

(51) Int. Cl. H02H 3/08; B60L 3/00; B60L 3/04; H01H 39/00; H02H 3/05; H02H 7/18

(52) U.S. Cl. CPC H02H 3/08; B60L 3/0046; B60L 3/04; H01H 39/006; H02H 3/05; H02H 7/18; H01H 2039/008

(57) ABSTRACT

An electrical assembly, comprising: a main current sensor; a main pyrotechnic fuse connected in series with the main current sensor; a first contactor connected in series with the main current sensor and the main pyrotechnic fuse; a first load circuit electrically connected to the first contactor and comprising: a first load current sensor; a first load pyrotechnic fuse; and a first control circuit comprising a first load pyrotechnic driver and a first load circuit aggregator; a second load circuit electrically connected to the first contactor in parallel with the first load circuit and comprising: a second load current sensor; a second load pyrotechnic fuse; and a second control circuit comprising a second load pyrotechnic driver and a second load circuit aggregator; and a local circuit.

### TECHNICAL FIELD

The present disclosure generally relates to electrical assemblies, including electrical assemblies that can, for example, be utilized in connection with vehicles.

### BRIEF DESCRIPTION OF THE DRAWINGS

While the claims are not limited to a specific illustration, an appreciation of various aspects may be gained through a discussion of various examples. The drawings are not necessarily to scale, and certain features may be exaggerated or hidden to better illustrate and explain an innovative aspect of an example. Further, the exemplary illustrations described herein are not exhaustive or otherwise limiting, and embodiments are not restricted to the precise form and configuration shown in the drawings or disclosed in the following detailed description. Exemplary illustrations are described in detail by referring to the drawings as follows:

FIG. 1 is a schematic view generally illustrating an embodiment of an electrical assembly according to teachings of the present disclosure.

FIG. 2 is a schematic view generally illustrating a vehicle including an embodiment of an electrical assembly according to teachings of the present disclosure.

FIG. 3 is a flow diagram generally illustrating an embodiment of a method of operating an electrical assembly according to teachings of the present disclosure.

FIG. 4 is a flow diagram generally illustrating an embodiment of a method of operating an electrical assembly according to teachings of the present disclosure.

FIG. 5 is a flow diagram generally illustrating an embodiment of a method of activating a pyrotechnic fuse of an electrical assembly according to teachings of the present disclosure.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

Embodiments of electrical assemblies disclosed herein can include pyrotechnic fuses that can be activated to disconnect electrical components to prevent or limit damage caused by overcurrent or current overload conditions, or for other purposes (e.g., in the event of a vehicle collision). Pyrotechnic fuses can operate more quickly to disconnect electrical components than other methods, such as thermal fuses. For example, thermal fuses rely typically rely on melting material, and the time involved with the melting can cause a delay between the initial occurrence of an overload or overcurrent condition (or other condition for disconnection), which can increase the opportunity for damage to electrical components. Embodiments of electrical assemblies disclosed herein can be compatible with high voltages (e.g., over 100 V, such as 400 V or 800 V). Pyrotechnic fuses can be more readily available, operate at lower temperatures, weigh less, and/or be smaller that thermal fuses. High voltages can present challenges with quickly disconnecting circuits via switches, such as contactors, and thermal fuses can be large and/or complex when designed for such high current. At least some embodiments of the disclosed electrical assemblies can overcome these challenges, such as via utilization of pyrotechnic fuses.

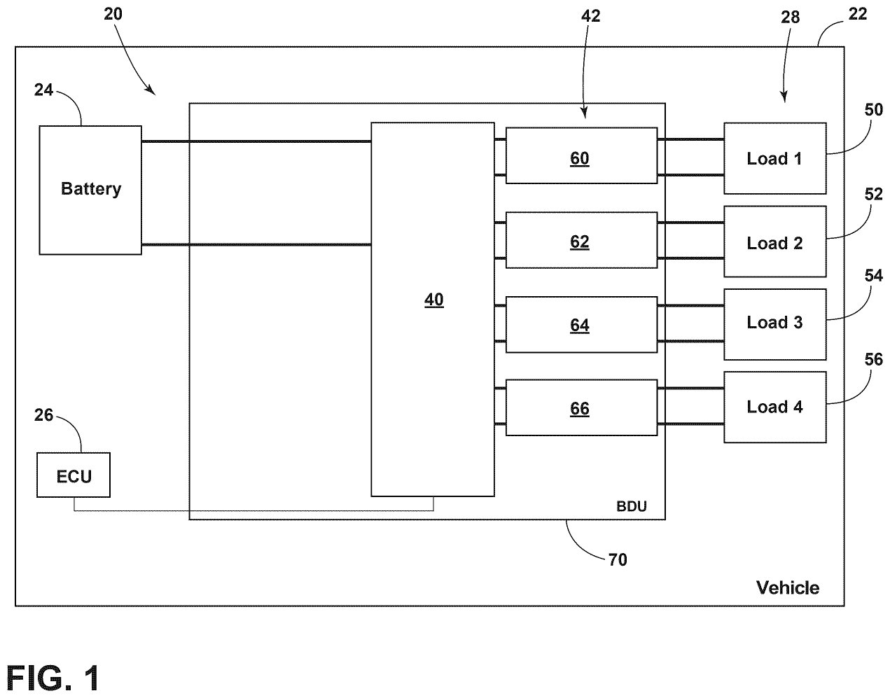

Referring to FIG. 1, an electrical assembly 20 is illustrated in a vehicle 22. The electrical assembly 20 includes or is connected to a battery 24 of the vehicle 22, a vehicle controller 26, and one or more electrical loads 28. The electrical assembly 20 is configured to selectively electrically connect and/or disconnect the battery 24 with the one or more electrical loads 28. For example, the electrical assembly 20 is configured to monitor the battery 24 and/or the one or more electrical loads 28 and mitigate overcurrent and overload conditions. The battery 24 is, for example, a high voltage battery configured to provide a voltage of at least 100 V, such as 400 V or 800 V.

The electrical assembly 20 includes a local circuit 40 electrically connected to the battery 24 and one or more load circuits 42 electrically connected between the local circuit 40 and the one or more loads 28. In the illustrated example, the one or more loads 28 include a first load 50, a second load 52, a third load 54, and a fourth load 56, and the one or more load circuits 42 include a first load circuit 60 connected to (e.g., between) the local circuit 40 and the first load 50, a second load circuit 62 connected to (e.g., between) the local circuit 40 and the second load 52, a third load circuit 64 connected to (e.g., between) the local circuit 40 and the third load 54, and a fourth load circuit 66 connected to (e.g., between) the local circuit 40 and the fourth load 56. The first, second, third, and fourth load circuits 60-66 and are connected in parallel with each other. Optionally, the one or more loads 28 each include one or more systems of the vehicle 22 (e.g., motors, chargers, etc.). For example, at least one of the first load 50 or the second load 52 can include a traction motor. The local circuit 40 and the one or more load circuits 42 are provided as a battery disconnect unit 70 (BDU) to mitigate overcurrent and overload conditions in the electrical assembly 20 and/or among the one or more loads 28.

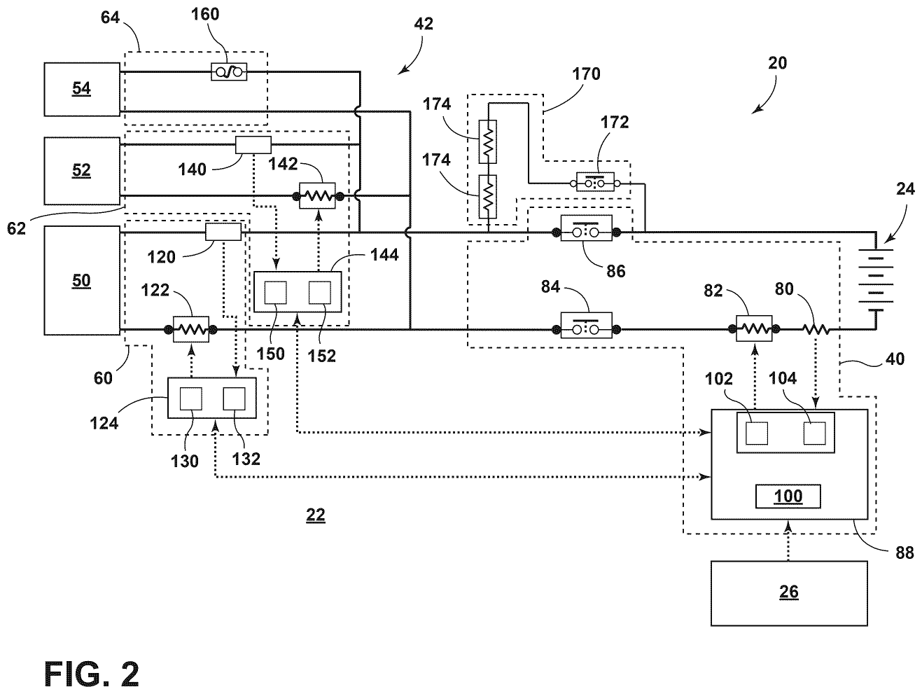

Referring to FIG. 2, the electrical assembly 20 is illustrated with the local circuit 40, the one or more loads 28 including the first, second, and third loads 50, 52, 54, and the one or more load circuits 42 including the first, second, and third load circuits 60, 62, 64. The first, second, and third load circuits 60, 62, 64 optionally include the first, second, and third loads 50, 52, 54, respectively. The local circuit 40 includes a main current sensor 80 connected to the battery 24 to sense a main current, a main pyrotechnic fuse 82 connected in series with the main current sensor 80, a first contactor 84 connected in series with the main current sensor 80 and the main pyrotechnic fuse 82, a second contactor 86 connected in series with the battery 24, and a local circuit 88 communicatively coupled with the main current sensor 80 and the main pyrotechnic fuse 82.

The local circuit 88 includes a local controller 100 (e.g., an electronic controller), a local driver 102, and a local aggregator 104. The local driver 102 is configured to activate the main pyrotechnic fuse 82, such as upon receiving a deployment signal from the local aggregator 104 and/or the local controller 100. The local driver 102, for example, comprises a current pulse generator. The local aggregator 104 is communicatively coupled with the main current sensor 80 to monitor the main current sensor 80 and obtain a main current of the electrical assembly 20. The local aggregator 104 is configured to sample the main current sensed by the main current sensor 80 for a local circuit period of time (e.g., an overcurrent period) to debounce the sensed main current (e.g., the output signal of the main current sensor 80). The local circuit period of time is, optionally, 50-100 microseconds. The local aggregator 104 is configured to determine whether the main current exceeds (e.g., continuously) a main current maximum for the local circuit period of time. In accordance with determining that the main current exceeds the main current maximum, the local aggregator 104 is configured to generate the deployment signal and provide the deployment signal to the local driver 102 to activate the main pyrotechnic fuse 82. The local driver 102 then generates an activation signal (e.g., a current pulse) that activates the main pyrotechnic fuse 82. Activating the main pyrotechnic fuse 82 electrically disconnects the battery 24 from the electrical assembly 20, or the other portions of the electrical assembly 20 if the battery 24 is included in the electrical assembly 20. Disconnecting the battery 24 protects the electrical assembly 20, the battery 24, and/or the one or more loads 28 from or limits the effects of overcurrent and current overload conditions.

The local circuit 40 is configured to receive a first activation signal, such as an external activation signal, from the vehicle controller 26. The first activation signal comprises a current pulse that could be provided directly to a pyrotechnic fuse, such as the main pyrotechnic fuse. Optionally, the local controller 100 is configured to conduct a data integrity check on the first activation signal, such as via receiving the first activation signal at a digital input and an analog input. The integrity check confirms that the correct signal is received. In accordance with receiving the first activation signal and, if conducted, confirming the integrity of the first activation signal, the local controller 100 is configured to send a deployment signal to the local driver 102 to cause the local driver 102 to generate a second activation signal and provide the second activation signal to the main pyrotechnic fuse 82. For example, the local circuit 40 receives the first activation signal, but does not provide the first activation signal to the local driver 102. Instead, the local circuit 40, via the local driver 102, generates a separate second activation signal that can have the same or similar properties as the first activation signal. Such a configuration can be beneficial to allow a single pyrotechnic fuse to be driven by a driver controlled by multiple inputs.

The first load circuit 60 comprises a first load current sensor 120, a first load pyrotechnic fuse 122, and a first load control circuit 124. The first load control circuit 124 comprises a first load pyrotechnic driver 130 and a first load circuit aggregator 132, and is configured to monitor the first load current sensor 120 and activate the first load pyrotechnic fuse 122. For example, the first load pyrotechnic driver 130 is communicatively coupled with the first load pyrotechnic fuse 122 to provide an activation signal thereto, and the first load circuit aggregator 132 is communicatively coupled with first load current sensor 120 to receive an output thereof corresponding to a first load current. In the illustrated example, the first load current sensor 120 is electrically connected between the first load 50 and the second contactor 86, and the first load pyrotechnic fuse 122 is electrically connected between the first load 50 and the first contactor 84.

The first load circuit aggregator 132 is configured to sample the first load current sensed by the first load current sensor 120 for a first period of time (e.g., an overcurrent period) to debounce the sensed first load current (e.g., the output signal of the first load current sensor 120). The first period of time is, optionally, 50-100 microseconds. The first load circuit aggregator 132 is configured to determine whether the first load current exceeds (e.g., continuously) a first load current maximum (e.g., a maximum threshold) for the first period of time. In accordance with determining that the first load current exceeds the first load current maximum for the first period of time, the first load circuit aggregator 132 is configured to generate a first load deployment signal and provide the first load deployment signal to the first load pyrotechnic driver 130 to activate the first load pyrotechnic fuse 122. The first load pyrotechnic driver 130 then generates a first load activation signal (e.g., a current pulse) that activates the first load pyrotechnic fuse 122. Activating the first load pyrotechnic fuse 122 electrically disconnects the first load circuit 60 from the battery 24. Disconnecting from the battery 24 protects the first load circuit 60, the first load 50, other portions of the electrical assembly 20, and/or the battery 24 from or limits the effects of overcurrent and current overload conditions.

The second load circuit 62 is configured in a corresponding manner for the second load 52. For example, the second load circuit 62 comprises a second load current sensor 140, a second load pyrotechnic fuse 142, and a second load circuit 144. The second load circuit 144 comprises a second load pyrotechnic driver 150 and a second load circuit aggregator 152, and is configured to monitor the second load current sensor 140 and activate the second load pyrotechnic fuse 142. For example, the second load pyrotechnic driver 150 is communicatively coupled with the second load pyrotechnic fuse 142 to provide an activation signal thereto, and the second load circuit aggregator 152 is communicatively coupled with second load current sensor 140 to receive an output thereof corresponding to a second load current. In the illustrated example, the second load current sensor 140 is electrically connected between the second load 52 and the second contactor 86, and the second load pyrotechnic fuse 142 is electrically connected between the second load 52 and the first contactor 84. In the illustrated example, the second load current sensor 140 is electrically connected between the second load 52 and the second contactor 86, and the second load pyrotechnic fuse 142 is electrically connected between the second load 52 and the first contactor 84.

The second load circuit aggregator 152 is configured to sample the second load current sensed by the second load current sensor 140 for a second period of time (e.g., an overcurrent period) to debounce the sensed second load current (e.g., the output signal of the second load current sensor 140). The second circuit period of time is, optionally, 50-100 microseconds. The second load circuit aggregator 152 is configured to determine whether the second load current exceeds (e.g., continuously) a second load current maximum (e.g., a maximum threshold) for the second period of time. In accordance with determining that the second load current exceeds the second load current maximum for the second period of time, the second load circuit aggregator 152 is configured to generate a second load deployment signal and provide the second load deployment signal to the second load pyrotechnic driver 150 to activate the second load pyrotechnic fuse 142. The second load pyrotechnic driver 150 then generates a second load activation signal (e.g., a current pulse) that activates the second load pyrotechnic fuse 142. Activating the second load pyrotechnic fuse 142 electrically disconnects the second load circuit 62 from the battery 24. Disconnecting from the battery 24 protects the second load circuit 62, the second load 52, other portions of the electrical assembly 20, and/or the battery 24 from or limits the effects of overcurrent and current overload conditions.

The third load circuit 64 includes a thermal fuse 160 connected between the first contactor 84 and the third load 54. The thermal fuse 160 is, for example, provided instead of a pyrotechnic fuse, a pyrotechnic driver, and an aggregator. Optionally, the third load circuit 64 comprises one or more components used for vehicle charging and that operate with relatively low currents compared to the first load circuit 60 and/or the second load circuit 62. For example, the first load circuit 60 and/or the second load circuit 62 can be configured for continuous currents of 300 A or more, with current spikes of over 1000 A, while the third load circuit 64 can be configured for continuous currents up to 100 A.

While the electrical assembly 20 is illustrated with four loads and load circuits in FIG. 1 and three loads and load circuits in FIG. 2, the electrical assembly 20 can include other numbers of at least two loads and load circuits.

Optionally, the main current sensor 80 is at least one more accurate or more precise than the first load current sensor 120 and/or the second load current sensor 140. For example, the main current sensor 80 optionally comprises a shunt and/or at least one of the first load current sensor 120 or the second load current sensor 140 comprises a Hall effect sensor. Utilzing less precise or less accurate sensors for the first load current sensor 120 and/or the second load current sensor 140 can simplify the load circuits 60, 62, allow for utilization of a wider range of sensor types, or a combination thereof.

Optionally, the local aggregator 104, the first load circuit aggregator 132, and/or the second load circuit aggregator 152 include respective integrated circuits configured to obtain sample values from a current sensor, such as current sensors 80, 120, 140, respectively, compare an average of the sample values to current maximums, and, in accordance with determining that the average exceeds the maximums, generate a deployment signal and provide the deployment signal to a pyrotechnic driver that activates a pyrotechnic fuse. Some or all of the aggregators 104, 132, 152 and/or the pyrotechnic drivers 102, 130, 150 can, optionally, operate via hardware only without software.

Additionally or alternatively, the local controller 100 is configured to monitor the aggregators 104, 132, 152 and/or the current sensors 80, 120, 140 and compare outputs thereof to thresholds (e.g., overload current thresholds) to determine whether to activate the corresponding pyrotechnic fuse 82, 122, 142. For example, if a sensed current exceeds the overload current threshold for an overload period of time, the local controller 100 can generate a deployment signal to cause the corresponding pyrotechnic driver 102, 130, 150 to generate the activation signal that activates the corresponding pyrotechnic fuse 82, 122, 142. The overload current thresholds are lower than the current maximums (e.g., overcurrent thresholds), and the overload period of time is longer than local circuit period, the first period, and the second period. For example, the overload thresholds can correspond to current levels that are not expected to cause immediate damage to electrical components, but could cause damage over longer periods of time. The local controller 100 can monitor the main current, the first current, and the second current over longer periods of time than the aggregators 104, 132, 152 and generate deployment signals for the corresponding pyrotechnic fuse 82, 122, 142 in accordance with the main current, the first current, or the second current exceeding the overload current thresholds for the overload period of time.

The electrical assembly 20 is shown with a precharge circuit 170 electrically connected in parallel with the second contactor 86, such as to precharge one or more of the first load circuit 60, the second load circuit 62, or the third load circuit 64. In the illustrated example, the precharge circuit 170 includes a precharge switch 172 and one or more precharge resistors 174 connected in series with the precharge switch 172. The precharge switch 172 is controllable by the vehicle controller 26, the local controller 100, and/or another controller. Optionally, the precharge circuit 170 includes other configurations.

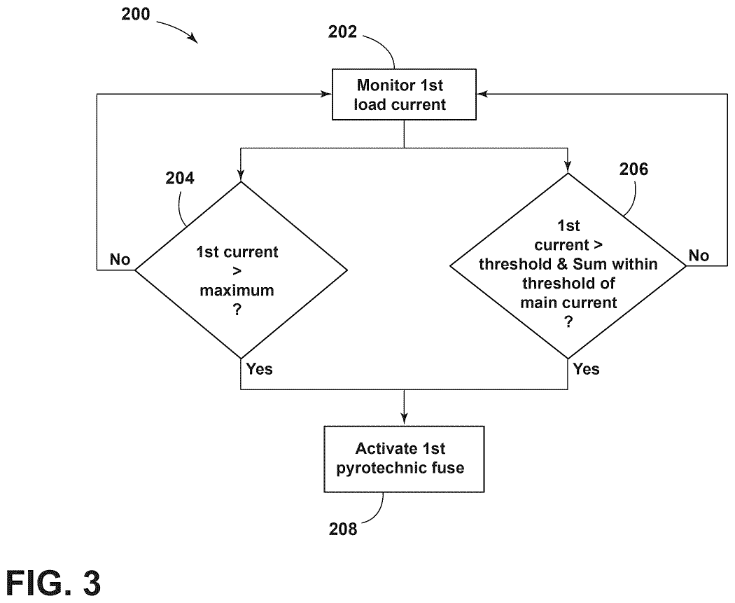

Referring to FIG. 3, a method 200 of operating the electrical assembly 20 is illustrated. The method 200 includes monitoring the first load current sensor 120 via the first load control circuit 124 and the local circuit 40 (block 202). The method 200 includes at least one of (i) the first load control circuit 124 determining that the first load current exceeds a first load current maximum for the first period of time (block 204), or (ii) the local circuit 40 determining that (a) the first load current exceeds a first current threshold, and (b) a sum of the first load current from the first load current sensor 120 and the second load current from the second load current sensor 140 is within a threshold (e.g., a tolerance) of the main current from the main current sensor 80 (block 206). For example, the local circuit 40 can compare the first load current to the first current threshold, calculate the sum of the first load current and the second load current, and compare the sum to the main current. The method 200 includes activating the first load pyrotechnic fuse 122 if the conditions of (i) or (ii) of block 204 and block 206, respectively, are met (block 208). Activating the first load pyrotechnic fuse 122 is conducted via the first load circuit aggregator 132 or the local controller 100 generating and sending a deployment signal to the first pyrotechnic driver 130. Comparing the sum to the main current can provide error checking to determine if a current sensor, such as the first load current sensor 120 or the main current sensor 80, are malfunctioning. For example, if the sum is not within the threshold, the local controller 100 can determine that at least one of the first load current sensor 120 or the main current sensor 80 is malfunctioning.

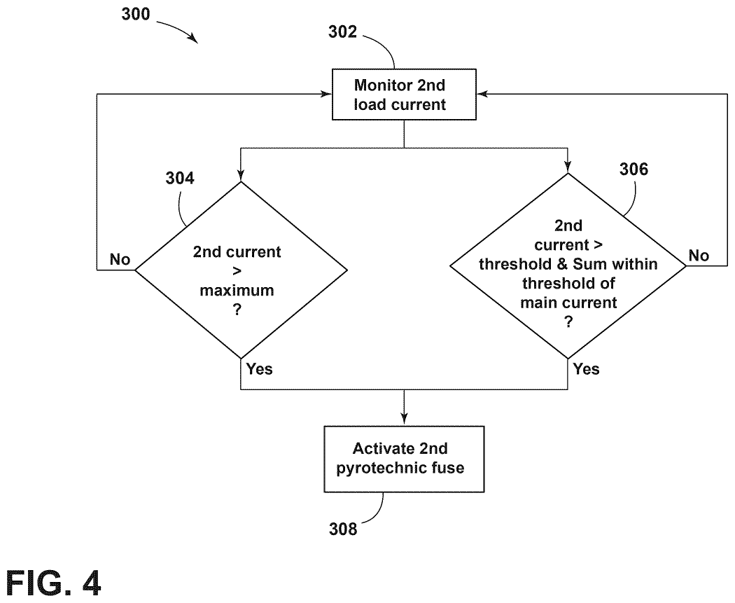

Referring to FIG. 4, a method 300 of operating the electrical assembly 20 is illustrated. The method 300 includes monitoring the second load current sensor 140 via the second load circuit 144 and the local circuit 40 (block 302). The method 300 includes at least one of (i) the second load circuit 144 determining that the second load current exceeds a second maximum current for the second period of time (block 304), or (ii) the local circuit 40 determining that (a) the second load current exceeds a second current threshold, and (b) a sum of the first load current from the first load current sensor 120 and the second load current from the second load current sensor 140 is within a threshold of the main current from the main current sensor 80 (block 306). For example, the local circuit 40 can compare the second load current to the second current threshold, calculate the sum of the first load current and the second load current, and compare the sum to the main current. The method 300 includes activating the second load pyrotechnic fuse 142 if the conditions of (i) or (ii) of block 304 and block 306, respectively, are met (block 308). Activating the second load pyrotechnic fuse 142 is conducted via the second load circuit aggregator 152 or the local controller 100 generating and sending a deployment signal to the second pyrotechnic driver 150.

Optionally, the method 200 of FIG. 3 and the method 300 of FIG. 4 can be combined and/or carried out simultaneously such that operating the electrical assembly includes some or all of blocks 202-208 and blocks 302-310.

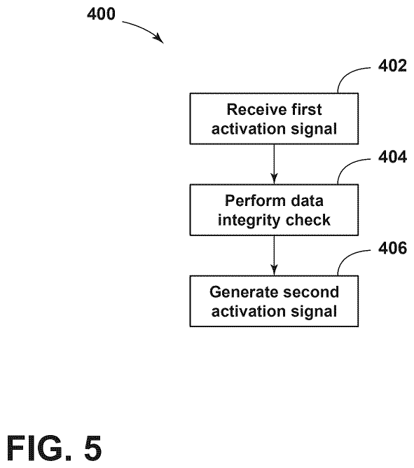

Operating the electrical assembly 20 can include activating the main pyrotechnic fuse 82. Referring to FIG. 5, a method 400 of activating the main pyrotechnic fuse 82 is illustrated that can in incorporated with the method 200 of FIG. 3, the method 300 of FIG. 4, or combinations thereof. The method 400 includes the local circuit receiving a first activation signal (block 402). The first activation signal is configured to activate the main pyrotechnic fuse 82 directly (e.g., without further signal generation from a pyrotechnic driver). The method 400 includes the local circuit 40 performing a data integrity check on the first activation signal (block 404), and, in accordance with the data integrity check confirming the integrity of the first activation signal, the local circuit 40 (e.g., the local driver 102) generating a second activation signal to activate the main pyrotechnic fuse 82 (block 406). Optionally, performing the data integrity check in block 404 includes the local circuit 40 receiving the first activation signal as a digital input and an analog input, and comparing the digital input with the analog input.

The aggregators 104, 132, 152 can each operate independently of each other and independently of the local controller 100 to activate the corresponding pyrotechnic fuses 82, 122, 142 (via the pyrotechnic drivers 102, 130, 150), and the local controller 100 can operate independently of the aggregators 104, 132, 152 to activate the corresponding pyrotechnic fuses 82, 122, 142 (via the pyrotechnic drivers 102, 130, 150).

Optionally, one or more of the methods 200, 300, 400 includes determining a state of change of the battery 24 (e.g., a vehicle battery) via the main current sensor 80.

The instant disclosure includes the following non-limiting embodiments:

An electrical assembly, comprising: a main current sensor; a main pyrotechnic fuse connected in series with the main current sensor; a first contactor connected in series with the main current sensor and the main pyrotechnic fuse; a first load circuit electrically connected to the first contactor and comprising: a first load current sensor; a first load pyrotechnic fuse; and a first control circuit comprising a first load pyrotechnic driver and a first load circuit aggregator, and configured to monitor the first load current sensor and to activate the first load pyrotechnic fuse; a second load circuit electrically connected to the first contactor in parallel with the first load circuit and comprising: a second load current sensor; a second load pyrotechnic fuse; and a second control circuit comprising a second load pyrotechnic driver and a second load circuit aggregator, and configured to monitor the second load current sensor and to activate the second load pyrotechnic fuse; and a local circuit comprising a local controller, a local driver, and a local aggregator, the local circuit configured to monitor the main current sensor, the first load current sensor, and the second load current sensor, and configured to selectively activate the main pyrotechnic fuse, the first load pyrotechnic fuse, and the second load pyrotechnic fuse.

The electrical assembly of any preceding embodiment, wherein the local circuit is configured to receive a first activation signal, generate a second activation signal according to the first activation signal, and provide the second activation signal to the main pyrotechnic fuse.

The electrical assembly of any preceding embodiment, wherein the first activation signal and the second activation signal comprise a respective pulse configured for directly activating the main pyrotechnic fuse.

The electrical assembly of any preceding embodiment, further comprising: a battery electrically connected in series with the first contactor, the main pyrotechnic fuse, and the main current sensor; and a second contactor connected in series with the battery; wherein the first load circuit includes a first electrical load electrically connected to the first load pyrotechnic fuse and the first load current sensor; and the second load circuit includes a second electrical load electrically connected to the second load pyrotechnic fuse and the second load current sensor.

The electrical assembly of any preceding embodiment, further comprising a precharge circuit comprising a precharge switch and precharge resistor connected in parallel with the second contactor.

The electrical assembly of any preceding embodiment, wherein the main current sensor is at least one of more accurate or more precise than the first load current sensor and the second load current sensor.

The electrical assembly of any preceding embodiment, wherein the main current sensor comprises a shunt.

The electrical assembly of any preceding embodiment, wherein at least one of the first load current sensor or the second load current sensor comprises a Hall effect sensor.

The electrical assembly of any preceding embodiment, wherein the local circuit is configured to compare a sum of a first load current from the first load current sensor and a second load current from the second load current sensor to a main current from the main current sensor.

The electrical assembly of any preceding embodiment, wherein the local circuit is configured to compare the first load current with a first load current threshold.

The electrical assembly of any preceding embodiment, wherein, in accordance with determining that (i) the sum is within a sensor threshold of the main current, and (ii) the first load current has exceeded the first load current threshold for a period of time, the local circuit is configured to activate the first load pyrotechnic fuse.

The electrical assembly of any preceding embodiment, wherein the first control circuit is configured to activate the first load pyrotechnic fuse independently of the local circuit.

The electrical assembly of any preceding embodiment, wherein the first load current sensor is configured for electrical currents of at least 300 A.

The electrical assembly of any preceding embodiment, wherein the first load circuit aggregator comprises an integrated circuit configured to obtain sample values from the first load current sensor, compare an average of the sample values to a first load current threshold, and, in accordance with determining that the average exceeds the first load current threshold, activate the first load pyrotechnic fuse.

A vehicle comprising the electrical assembly of any preceding embodiment; wherein at least one of the first electrical load or the second electrical load comprises a traction motor.

A vehicle comprising: the electrical assembly of any preceding embodiment, further comprising: a battery electrically connected in series with the first contactor, the main pyrotechnic fuse, and the main current sensor; and a second contactor connected in series with the battery; wherein the first load circuit includes a first electrical load electrically connected to the first load pyrotechnic fuse and the first load current sensor; the second load circuit includes a second electrical load electrically connected to the second load pyrotechnic fuse and the second load current sensor; and at least one of the first electrical load or the second electrical load comprises a traction motor.

A method of operating the electrical assembly of any preceding embodiment, the method comprising: monitoring the first load current sensor via the first control circuit and the local circuit; and activating the first load pyrotechnic fuse in accordance with at least one of (i) the first control circuit determining that a first load current exceeds a first maximum current, or (ii) the local circuit determining that (a) the first load current exceeds a first current threshold for a first period of time, and (b) a sum of the first load current from the first load current sensor and a second load current from the second load current sensor is within a sensor threshold of a main current from the main current sensor.

The method of any preceding embodiment, further comprising: monitoring the second load current sensor via the second control circuit and the local circuit; and activating the second load pyrotechnic fuse via the second control circuit or the local circuit in accordance with at least one of (i) the second control circuit determining that the second load current exceeds a second maximum current, or (ii) the local circuit determining that (a) the second load current exceeds a second current threshold for a second period of time, and (b) the sum of the first load current and the second load current is within the sensor threshold of the main current.

A method of operating the electrical assembly of any preceding embodiment, the method comprising: activating the main pyrotechnic fuse, the activating including: the local circuit receiving a first main activation signal configured to activate the main pyrotechnic fuse; the local circuit performing a data integrity check on the first main activation signal; and the local circuit generating a second main activation signal configured to activate the main pyrotechnic fuse.

The method of any preceding embodiment, wherein performing the data integrity check includes the local circuit receiving the first main activation signal as a digital input and an analog input and comparing the digital input with the analog input.

The method of any preceding embodiment, further comprising determining a state of charge of a vehicle battery via the main current sensor.

A vehicle including the electrical assembly of any preceding embodiment.

An electronic controller configured to implement the method of any preceding embodiment.

A non-transitory computer-readable storage medium having a computer program encoded thereon for implementing the method of any preceding embodiment.

In examples, a controller (e.g., the vehicle controller 26 and the local controller 100) may include an electronic controller and/or include an electronic processor, such as a programmable microprocessor and/or microcontroller. In embodiments, a controller may include, for example, an application specific integrated circuit (ASIC) and/or an embedded controller. A controller may include a central processing unit (CPU), a memory (e.g., a non-transitory computer-readable storage medium), and/or an input/output (I/O) interface. A controller may be configured to perform various functions, including those described in greater detail herein, with appropriate programming instructions and/or code embodied in software, hardware, and/or other medium. In embodiments, a controller may include a plurality of controllers. In embodiments, a controller may be connected to a display, such as a touchscreen display.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “in the illustrated example,” “various embodiments,” “with embodiments,” “in embodiments,” “an embodiment,” “with some configurations,” “in some configurations,” or the like, means that a particular feature, structure, or characteristic described in connection with the example/embodiment is included in at least one embodiment. Thus, appearances of the phrases “examples, “in examples,” “with examples,” “in the illustrated example,” “in various embodiments,” “with embodiments,” “in embodiments,” “an embodiment,” “with some configurations,” “in some configurations,” or the like, in places throughout the specification are not necessarily all referring to the same embodiment. Furthermore, the particular features, structures, and/or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof. The word “exemplary” is used herein to mean “serving as a non-limiting example.”

It should be understood that references to a single element are not necessarily so limited and may include one or more of such element, unless the context clearly indicates otherwise. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above. The term “at least one of” in the context of, e.g., “at least one of A, B, and C” or “at least one of A, B, or C” includes only A, only B, only C, or any combination or subset of A, B, and C, including any combination or subset of one or a plurality of A, one or a plurality of B, and one or a plurality of C. A “set” of elements can include any number of one or more elements.

Although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. The term “and/or” as used herein refers to and encompasses any and all possible combinations of one or more of the associated listed items. Uses of “and” and “or” are to be construed broadly (e.g., to be treated as “and/or”). For example and without limitation, uses of “and” do not necessarily require all elements or features listed, and uses of “or” are inclusive unless such a construction would be illogical. The terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

References to a vehicle can include one or more of a variety of vehicles, including, without limitation, a passenger car (e.g., a sedan, a pickup truck, a sport utility vehicle, a crossover, etc.), a truck, a bus, a plane, or a boat, among others.

All matter contained in the above description or shown in the accompanying drawings shall be interpreted as illustrative only and not limiting. Changes in detail or structure may be made without departing from the present disclosure.

A controller, an electronic control unit (ECU), a system, and/or a processor as described herein may include a conventional processing apparatus known in the art, which may be capable of executing preprogrammed instructions stored in an associated memory, all performing in accordance with the functionality described herein. To the extent that the methods described herein are embodied in software, the resulting software can be stored in an associated memory and can also constitute means for performing such methods. Such a system or processor may further be of the type having ROM, RAM, RAM and ROM, and/or a combination of non-volatile and volatile memory so that any software may be stored and yet allow storage and processing of dynamically produced data and/or signals.

An article of manufacture in accordance with this disclosure may include a non-transitory computer-readable storage medium having a computer program encoded thereon for implementing logic and other functionality described herein. The computer program may include code to perform one or more of the methods disclosed herein. Such embodiments may be configured to execute via one or more processors, such as multiple processors that are integrated into a single system or are distributed over and connected together through a communications network, and the communications network may be wired and/or wireless. Code for implementing one or more of the features described in connection with one or more embodiments may, when executed by a processor, cause a plurality of transistors to change from a first state to a second state. A specific pattern of change (e.g., which transistors change state and which transistors do not), may be dictated, at least partially, by the logic and/or code.

What is claimed is:

1. An electrical assembly, comprising:
a main current sensor;
a main pyrotechnic fuse connected in series with the main current sensor;
a first contactor connected in series with the main current sensor and the main pyrotechnic fuse;
a first load circuit electrically connected to the first contactor and comprising:
a first load current sensor;
a first load pyrotechnic fuse; and
a first control circuit comprising a first load pyrotechnic driver and a first load circuit aggregator, and configured to monitor the first load current sensor and to activate the first load pyrotechnic fuse;
a second load circuit electrically connected to the first contactor in parallel with the first load circuit and comprising:
a second load current sensor;
a second load pyrotechnic fuse; and
a second control circuit comprising a second load pyrotechnic driver and a second load circuit aggregator, and configured to monitor the second load current sensor and to activate the second load pyrotechnic fuse; and
a local circuit comprising a local controller, a local driver, and a local aggregator, the local circuit configured to monitor the main current sensor, the first load current sensor, and the second load current sensor, and configured to selectively activate the main pyrotechnic fuse, the first load pyrotechnic fuse, and the second load pyrotechnic fuse.

2. The electrical assembly of claim 1, wherein the local circuit is configured to receive a first activation signal, generate a second activation signal according to the first activation signal, and provide the second activation signal to the main pyrotechnic fuse.

3. The electrical assembly of claim 2, wherein the first activation signal and the second activation signal comprise a respective pulse configured for directly activating the main pyrotechnic fuse.

4. The electrical assembly of claim 1, further comprising:
a battery electrically connected in series with the first contactor, the main pyrotechnic fuse, and the main current sensor; and
a second contactor connected in series with the battery;
wherein the first load circuit includes a first electrical load electrically connected to the first load pyrotechnic fuse and the first load current sensor; and
the second load circuit includes a second electrical load electrically connected to the second load pyrotechnic fuse and the second load current sensor.

5. The electrical assembly of claim 4, further comprising a precharge circuit comprising a precharge switch and precharge resistor connected in parallel with the second contactor.

6. The electrical assembly of claim 1, wherein the main current sensor is at least one of more accurate or more precise than the first load current sensor and the second load current sensor.

7. The electrical assembly of claim 6, wherein the main current sensor comprises a shunt.

8. The electrical assembly of claim 7, wherein at least one of the first load current sensor or the second load current sensor comprises a Hall effect sensor.

9. The electrical assembly of claim 1, wherein the local circuit is configured to compare a sum of a first load current from the first load current sensor and a second load current from the second load current sensor to a main current from the main current sensor.

10. The electrical assembly of claim 9, wherein the local circuit is configured to compare the first load current with a first load current threshold.

11. The electrical assembly of claim 10, wherein, in accordance with determining that (i) the sum is within a sensor threshold of the main current, and (ii) the first load current has exceeded the first load current threshold for a period of time, the local circuit is configured to activate the first load pyrotechnic fuse.

12. The electrical assembly of claim 11, wherein the first control circuit is configured to activate the first load pyrotechnic fuse independently of the local circuit.

13. The electrical assembly of claim 1, wherein the first load current sensor is configured for electrical currents of at least 300 A.

14. The electrical assembly of claim 1, wherein the first load circuit aggregator comprises an integrated circuit configured to obtain sample values from the first load current sensor, compare an average of the sample values to a first load current threshold, and, in accordance with determining that the average exceeds the first load current threshold, activate the first load pyrotechnic fuse.

15. A vehicle comprising:
the electrical assembly of claim 1, further comprising:
a battery electrically connected in series with the first contactor, the main pyrotechnic fuse, and the main current sensor; and
a second contactor connected in series with the battery;
wherein the first load circuit includes a first electrical load electrically connected to the first load pyrotechnic fuse and the first load current sensor;
the second load circuit includes a second electrical load electrically connected to the second load pyrotechnic fuse and the second load current sensor; and
at least one of the first electrical load or the second electrical load comprises a traction motor.

16. A method of operating the electrical assembly of claim 1, the method comprising:
monitoring the first load current sensor via the first control circuit and the local circuit; and
activating the first load pyrotechnic fuse in accordance with at least one of (i) the first control circuit determining that a first load current exceeds a first maximum current, or (ii) the local circuit determining that (a) the first load current exceeds a first current threshold for a first period of time, and (b) a sum of the first load current from the first load current sensor and a second load current from the second load current sensor is within a sensor threshold of a main current from the main current sensor.

17. The method of claim 16, further comprising:
monitoring the second load current sensor via the second control circuit and the local circuit; and
activating the second load pyrotechnic fuse via the second control circuit or the local circuit in accordance with at least one of (i) the second control circuit determining that the second load current exceeds a second maximum current, or (ii) the local circuit determining that (a) the second load current exceeds a second current threshold for a second period of time, and (b) the sum of the first load current and the second load current is within the sensor threshold of the main current.

18. A method of operating the electrical assembly of claim 1, the method comprising:
activating the main pyrotechnic fuse, the activating including:
the local circuit receiving a first main activation signal configured to activate the main pyrotechnic fuse;
the local circuit performing a data integrity check on the first main activation signal; and
the local circuit generating a second main activation signal configured to activate the main pyrotechnic fuse.

19. The method of claim 18, wherein performing the data integrity check includes the local circuit receiving the first main activation signal as a digital input and an analog input and comparing the digital input with the analog input.

20. The method of claim 18, further comprising determining a state of charge of a vehicle battery via the main current sensor.
